(19) United States
(12) Patent Application Publication
(10) Pub. No.: US 2016/0231731 A1
(43) Pub. Date: Aug. 11, 2016

(54) SYSTEM, METHOD AND APPARATUS FOR USER INTERACTION WITH A WORKSTATION

(71) Applicant: StandLogix, Inc, Boulder, CO (US)

(72) Inventors: ERIK CARVER, Boulder, CO (US); Peter Silva, Louisville, CO (US); Evan Patronik, Boulder, CO (US)

(21) Appl. No.: 15/040,924

(22) Filed: Feb. 10, 2016

Related U.S. Application Data
(60) Provisional application No. 62/114,568, filed on Feb. 10, 2015.

(51) Int. Cl. G05B 19/4063

(52) U.S. Cl. CPC G05B 19/4063; G05B 2219/31229

(57) ABSTRACT

The present invention pertains in general to a system, method and apparatus to track a user's interaction with a workstation surrounding the sensing of user presence, user orientation workstation height for association with an identified user and providing notifications to the user for the purposes of recommending standing or seated user orientation as directed by system analysis and allowing access and tacking of such tracking and notifications by users, employers or other predetermined third-parties.

### CROSS REFERENCE TO REFERENCE TO RELATED APPLICATIONS

This application claims the benefit of U.S. Provisional Patent Application 62/114,568 entitled “SYSTEM, METHOD AND APPARATUS FOR USER INTERACTION WITH A WORKSTATION” filed on Feb. 10, 2015, the entire contents of which are incorporated herein by reference in its entirety for all purposes.

### FIELD OF THE INVENTION

The present invention pertains in general to a system, method and apparatus to track a user's interaction with a workstation surrounding the user's presence and orientation at the workstation and interaction, and the system interacting with that user to provide feedback surrounding the amount of time sitting and/or standing.

### BACKGROUND OF THE INVENTION

Positive physiological health is generally accepted as associated with moderate to high-intensity physical activity. Those with higher activity habits or more active lifestyles are statistically in better healthier and have a lower incidence of health problems. There are also fewer complications associated with sedentary or non-active lifestyles, such as cardiovascular disease, obesity and diabetes, amongst other physical afflictions.

More recent studies identify sedentary habits and behavior such as prolonged sitting to have negative effects and potentially reversing the benefits gained through positive physical activities. This causes great concern to many given the large percentage of people who spend a majority if not the entirety of their day sitting, often working at a computer.

Some existing solutions to address the negative effects of sitting for long periods of time surround the use of standing workstations of many forms. Some standing workstations are fixed-height workstations, with a set height suited for the particular user's use when standing. Other standing workstations are dynamic workstations, which allow to the user to raise and lower a workstation to various sitting and standing heights accommodating any user along with their preference to stand or sit throughout a period of work. This dynamic movement can be accomplished with manual mechanism or powered mechanical means. Dynamic workstations are substantially higher in cost than a fixed height solution. Other standing workstation solutions provide a dynamic platform affixed to an existing fixed-height sitting workstation at a lower cost to allow the use of the workstation in a standing or sitting configuration without replacing a full workstation. Further still, some forms of standing workstations incorporate treadmills or other dynamic physiological activity based exercise in coordination with use of the workstation.

Some of the benefits associated with the use of standing workstations of any form have been proven to include a higher heart-rate, indicating increased activity level, an increased rate of calorie consumption and a healthier blood-glucose range.

### SUMMARY OF THE INVENTION

The tracking of a user's interaction with a standing workstation surrounds the monitoring, recording and analysis of variables surrounding the user. Such variables include sensing the presence of a user, determining the identity of the user and determining if the user is standing or sitting.

Certain embodiments of the invention seek to identify a user through wireless detection while mitigating the possibility of false positive situations. False positive situations are most probable with closely situated workstations or individuals. One example of a potential false positive situation may involve a workstation A, sensing the presence of user B who is actively using workstation B, rather than user A who is actively using workstation A. The invention disclosed herein uses a system to provide positive recognition of a user's identified presence at a workstation with through the use of sensor systems such as infrared, ultrasonic or radar technologies. The system identity of the user present at a workstation may be indicated by detection of a personal identification token. Each personal identification token is unique to a user. A personal identification token may have pre-stored information about a user, or may provide a unique user identifier, which the system uses to access pre-stored information about a user. Certain embodiments of a personal identification token may comprise a module, which must be physically inserted or docked into a system receptacle such as a USB dongle. Alternative embodiments of a wireless based personal identification token may be in the form of a smartphone, RFID, or other wireless enabled device. A personal identification token may store information that is transferred to the system via wireless protocol such as RFID, Bluetooth®, Zigbee® or other wireless technologies. The system may use a hierarchical protocol associated with personal identification tokens to mitigate false positives. To further mitigate problems involving closely situated workstations, certain embodiments of a system as used in coordination with a workstation, wherein the workstation is typically used only by a particular individual, the system may be preprogrammed to identify any present user as that particular individual.

The invention disclosed herein provides a system and method to sense user presence, user orientation and workstation configuration devices and provide notification to the user surrounding such information as activity levels, time standing, and cues to stand or sit. Furthermore, this information may be also provided to third parties including management and/or insurance companies implementing programs to encourage healthy workplace habits.

Due to the proven widely accepted benefits of decreased sedentary habits such as sitting for extended periods of time, standing workstations have garnered interest by health insurance providers due to lower costs associated with health care and health insurance. Health insurance companies already provide discounted coverage to the insured in return for partaking programs involving vigorous or moderate activities with quantifiable tracking. These can take the form of pedometers, fitness trackers, wearable smart technology such as a Fitbit® or the like, tracking gym visits and other quantifiable means.

Because of a correlated benefit surrounding the use of standing workstations and a decreased cost of insuring an individual or group that use standing workstations, health insurance companies have incentive to pass cost savings to individuals or groups that use standing workstations. This correlated benefit presents a problem surrounding the need to provide the insurance company a verifiable quantification method to determine the level of participation, or duration of standing time of an individual.

In certain embodiments, the present invention uses a plurality of sensors in the form of a thermal presence sensor to identify the presence of a user and an IR sensor that rely on IR light radiation to detect the orientation of a user. In such embodiments the presence sensors are mounted to the underside of the workstation work-surface proximate to the leading longitudinal plane of the workstation and oriented such that the field of detection is substantially toward the medial plan. The orientation sensors are mounted on alternate sides, equidistantly from the medial plane and equidistantly from the leading longitudinal plane. The thermal presence sensor is mounted proximate to the leading longitudinal plane with the field of sensing of the thermal sensor directed medially.

In certain embodiments, an orientation sensor is mounted to the underside of a workstation work-surface, offset from the medial line and typically in the front half of the workstation. The sensing direction of the orientation sensor is parallel to the leading longitudinal plane or angled toward the angled toward the leading longitudinal plane by up to 10-degrees. The orientation sensor is directed 25-35 degrees downward away from the workstation work-surface. The orientation sensor on either sides of the medial plane, typically equidistant from the medial plane and a distal end. A thermal presence sensor is mounted to the underside of the workstation work-surface offset from the medial plane, typically on the back half of the workstation offset from the medial plane and typically equidistant from the medial plane and a distal end. It may be preferred to mount the thermal presence sensor on the opposite side of the medial plane from the orientation sensor. The thermal presence sensor is angled toward the intersection of the leading longitudinal plane and the medial plane and directed 25-45 degrees downward from the workstation work-surface.

Other embodiments of the invention use a system utilizing radar technology and wireless communication protocols to detect the presence of a user as well as the orientation of the user at the workstation. A radar transceiver that is mounted under the workstation work-surface provides physical detection of user presence and may provide further detection of such factors as work-surface height from the floor on which the workstation rests and user proximity. The radar transceiver also provides the distance of a user's legs from the radar transceiver, relative to a predetermined threshold. The predetermined threshold can include he leading longitudinal edge of the workstation. The distance of a user's legs from the radar transceiver relative to the leading longitudinal edge of the workstation may provide indication of if a user is seated or standing.

Certain embodiments of the invention as disclosed herein provide the creation and aggregation of data surrounding general work habits having correlation with beneficial health outcomes and lower health related costs. The increase of such habits allows for a healthier individual, healthier workforce and lower cost of insurance. Benefits of a healthier individual include increased profitability for the health insurance providers, lower overhead for companies that subsidize or pay for employee health insurance and lower cost of insurance for an employee. It will be appreciated that the acquisition of data may be used to establish the baseline physical activity levels of a workforce and improvements in physical and mental health. The collection and aggregation of this data allows further statistical correlation between the activity of an individual and the health benefits. As a stronger correlation is made, smaller sample sizes can be used while maintaining a similar or higher level of confidence. As such, an insurance company can operate with the basis of a more accurate costing of health insurance with limited data sets for a group of individuals or an individual's activities over a shorter period of time. Furthermore, the aggregation of such data provides interested parties with insight into mitigating risk with health and wellbeing assessment based on increased and sustained physical activity. This assessment of risk mitigation based on aggregated data can allow prediction of individual or workforce health based on a based on a more discrete and smaller sample size of data. This will provide interested parties such as a health insurance provider to more accurately predict the cost of insurance for a workforce, comprising one or more people, to drive cost savings for both health insurance providers and their policyholders.

In use, a system for detecting the interactions of a user with a workstation comprising the functionality to determine the presence, identity and orientation of a user surrounding the use of the workstation. The system uses a presence sensor to determine the physical presence of a user and uses a user orientation sensor to determine if the user is in a standing or sitting configuration. A personal identification token sensor unit detects a personal identification token associated with the user. Once the system has determined information surrounding the presence, orientation and identity of the user, the system merges the information and communicates data to a cloud based or web-portal based aggregation site through the use of wired or wireless communication protocols. The aggregation site, upon receipt of this data, communicates with the system to confirm the receipt of the data. The data may be made available to the user as well as third parties such as an employer, employer department such as human resources or a third-party such as a health insurance provider. The data may be analyzed through predetermined analysis in aggregation site or by others including the user or a third-party. A third-party may analyze the merged information per user's record individually or as a group as may pertain to a workforce or focus group. The analysis of a group, such as a workforce, allows the third-party to assess the overall workforce health and provide a quantifiable health-rating index. A health-rating index may be used by a third-party to determine a insurance rates or health benefit incentives to provide to an employer for a work-force or directly to a user.

### BRIEF DESCRIPTION OF THE FIGURES

FIG. 1A. Side perspective side view of a workstation with an embodiment of a system comprising a first sensor suite affixed to a workstation.

FIG. 1B. Front perspective view of a workstation with an embodiment of a system comprising a first sensor suite and a second sensor suite.

FIG. 2A. A bottom view of a workstation work-surface with an embodiment of a system comprising a first sensor suite with a presence sensor.

FIG. 2B. A bottom view of a workstation work-surface with an embodiment of a system comprising a first sensor suite and a thermal presence sensor.

FIG. 2C. A bottom view of a workstation work-surface with an embodiment of a system comprising a first sensor suite, thermal presence sensor, a first user orientation sensor and optional second user orientation sensor.

FIG. 2D. A front view of a workstation with an embodiment of a system comprising a first desk height sensor and optional second desk height sensor.

FIG. 2E. A perspective view of a workstation with an embodiment of a system comprising a first desk height sensor and optional second desk height sensor.

FIG. 3A. A bottom view of a workstation worksurface comprising an embodiment of a system comprising a radar transceiver.

FIG. 3B. A side perspective view of a workstation comprising an embodiment of a system comprising a radar transceiver.

FIG. 4. A front view of a workstation with an embodiment of a system comprising a personal identification token and a personal identification token sensor.

FIG. 5A. A side perspective view of a workstation comprising an embodiment of a system comprising virtual boundaries.

FIG. 5B. A side perspective view of a workstation comprising an embodiment of a system comprising virtual boundaries.

FIG. 6. An embodiment of a personal identification token sensing device.

FIG. 7. A certain embodiment of a system.

FIG. 8. A certain embodiment of the process flow of a certain embodiment.

FIG. 9. A certain embodiment a plurality of systems communicating through a central hub.

### DETAILED DESCRIPTION OF CERTAIN EMBODIMENTS

The method and system described herein pose novel and effective solutions to problems associated with the tracking of users engaging in healthier workplace habits. The healthier workplace habits focus on the use of but are not limited to the use of standing workstations.

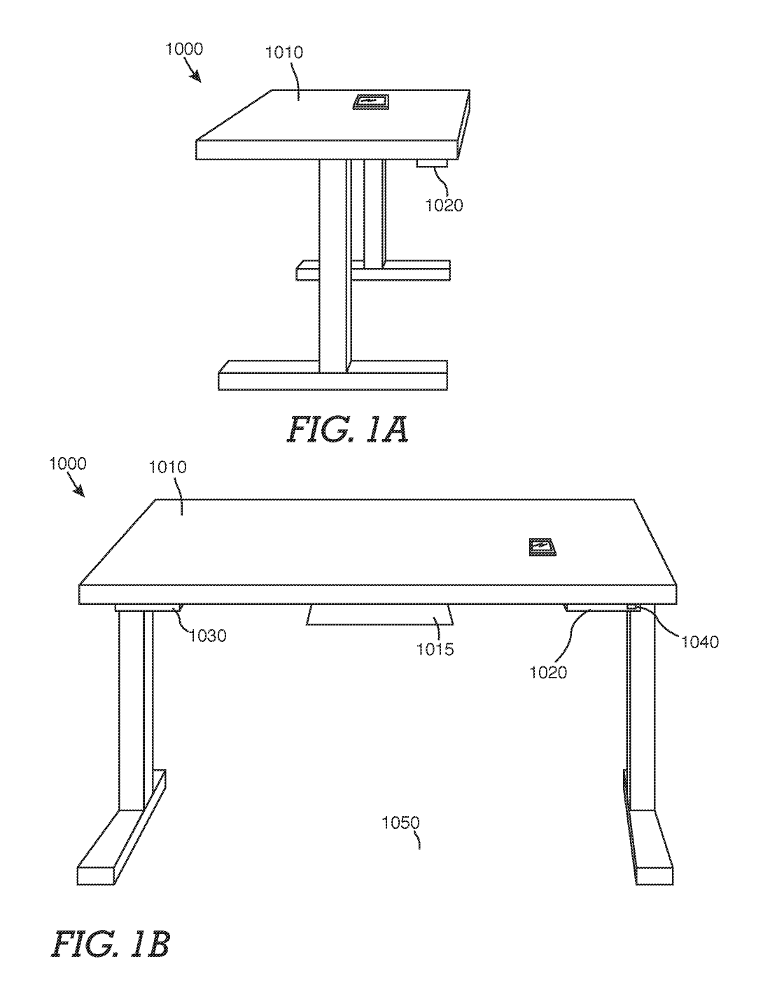

Certain embodiments of the invention comprise a plurality of sensors, and at least one computing device affixed to an adjustable height workstation 1000. It will be appreciated by those skilled in the art that the working height of an adjustable height workstation 1000 can be adjusted by changing the workstation work-surface 1010 height, by adjustment of a keyboard 1015 tray enabling standing use of a fixed-height sitting workstation or other means known to those skilled in the art. As shown in a front-view in FIG. 1A, such embodiments further comprise a first sensor-suite 1020 and optionally a second sensor-suite 1030 as related to a system mounted to the underside of the workstation work-surface 1010. A first sensor-suite includes certain functionalities, such as user presence sensing, height sensing, user orientation sensing in relation to user/workstation through the use of at least one sensor. The system further comprises a computing device 1035 and other components related to a computing device 1035, which may be integrated into the first sensor-suite 1020. Such components may include a USB receptacle 1040 and/or wireless communication capability for the positive identification of a user. The use of a second sensor-suite 1030 may be used to provide sensing capabilities redundant to the first sensor-suite 1020 or adding sensing capability to the system. It will be appreciated that a sensor-suite may comprise a singular sensor device serving a singular sensing function, a singular sensor device serving a plurality of sensing functions or a plurality of sensor devices serving a plurality of sensing functions.

Certain embodiments of the system comprise a presence-sensor to detect the physical presence of a user. A presence sensor used for user detection may comprise one or more sensors for object detection. Such sensors include, but are not limited to, infrared sensors, thermographic sensors, and radar based sensors.

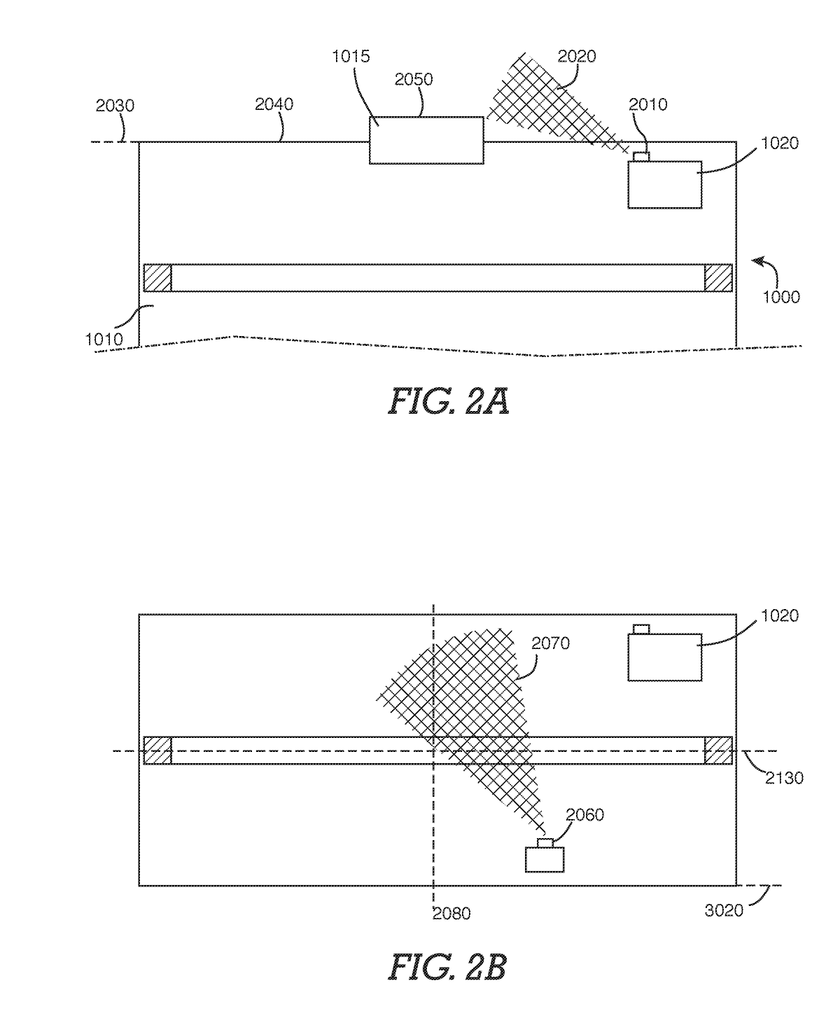

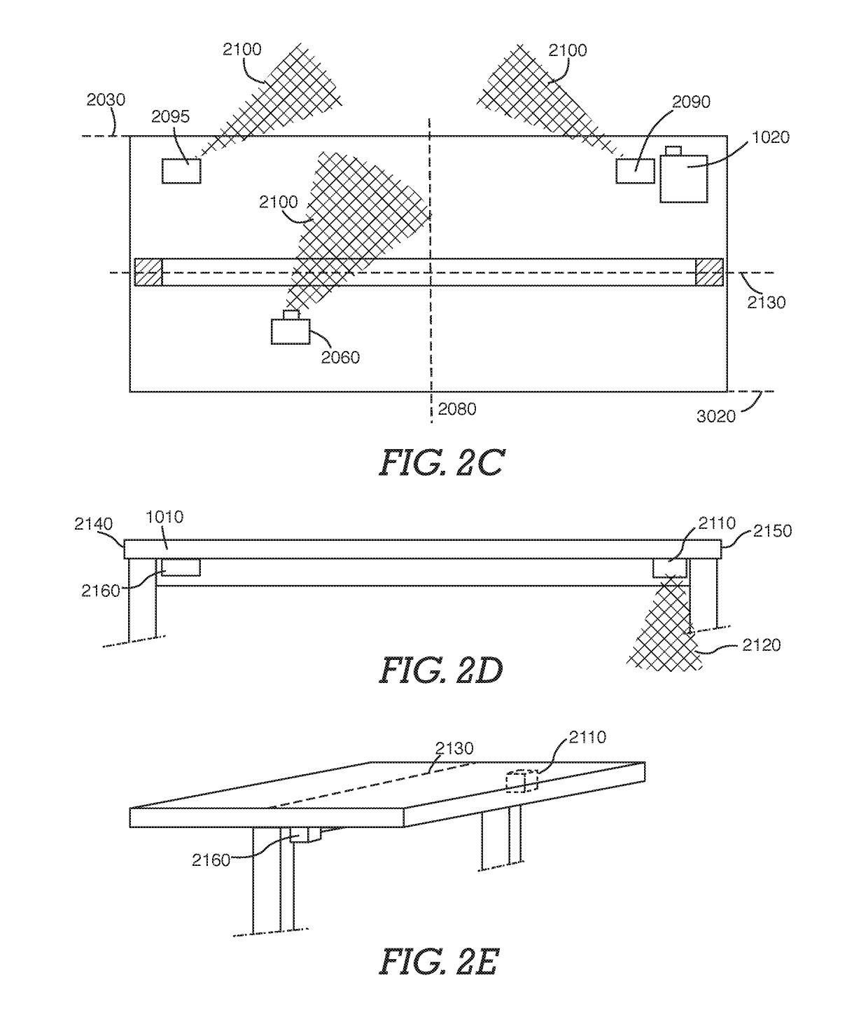

Certain embodiments of a first sensor-suite 1020, as shown in FIG. 2A, comprise a presence sensor 2010 wherein the sensor-suite is affixed to a workstation, typically to the underside of the workstation work-surface 1010. A presence sensor 2010 may detect the approach, presence and/or departure of a user from a workstation. The use of a presence sensor 2010 typically involves a field of detection 2020 extending beyond the leading longitudinal plane 2030 as shown in FIG. 2.

It will be appreciated to those skilled in the art that a leading longitudinal plane 2030 is defined by a leading edge of a workstation 1000 where a user stands or sits proximal to when using the workstation. The leading edge of a workstation 1000 may be defined by the leading edge of a workstation work-surface 2040, a leading edge 2050 of a keyboard tray 1015 that extends toward a user beyond the leading edge 2040 of a workstation work-surface 1010, or other objects that modify the user to workstation 1000 interface distance.

Certain embodiments of a system as shown in FIG. 2B further comprises a thermal sensor 2060 that detects changes in the ambient temperature near the workstation in the direction of a possible to indicate the presence of a user. A thermal sensor 2060 as used in such embodiments is offset to the left or right of the medial plane 2080 and placed between a longitudinal midline 2130 and a trailing longitudinal edge 3020, mounted to the underside of a workstation work-surface 1010. The field of detection 2070 of the thermal sensor 2060 is directed outward toward the location of a potential user, typically at the intersection of the medial plane 2080 and the leading longitudinal plane 2030. It will be appreciated that a thermal sensor 2060 may comprise, but is not limited to, infrared (IR) thermometers or thermographic sensors.

Certain embodiments of the present invention as shown in FIG. 2C comprises an infrared orientation sensor 2090 that relies on infrared light radiation and a thermal presence sensor 2060 to identify presence and orientation of a user. A first orientation sensor 2090 is mounted to the underside of the workstation work-surface 1010 proximate to the leading longitudinal plane 2030 of the workstation 1000 and oriented such that the field of detection 2100 is substantially toward the medial plane 2080. The first orientation sensor 2090 is mounted offset from the medial plane 2080 and offset from the leading longitudinal plane 2030 of the workstation 1000. A second orientation sensor 2095 may be used and is typically mounted on the alternate side of the medial plane 2080 from the first orientation sensor 2090. The mounting offsets of the second orientation sensor 2095 from the medial plane 2080 and leading longitudinal plane 2030 are equal to the respective offsets of the first orientation sensor 2090. The thermal presence sensor 2060 is mounted to the underside of the workstation work-surface and configured to sense thermal changes proximate to the leading longitudinal plane 2030 of the workstation.

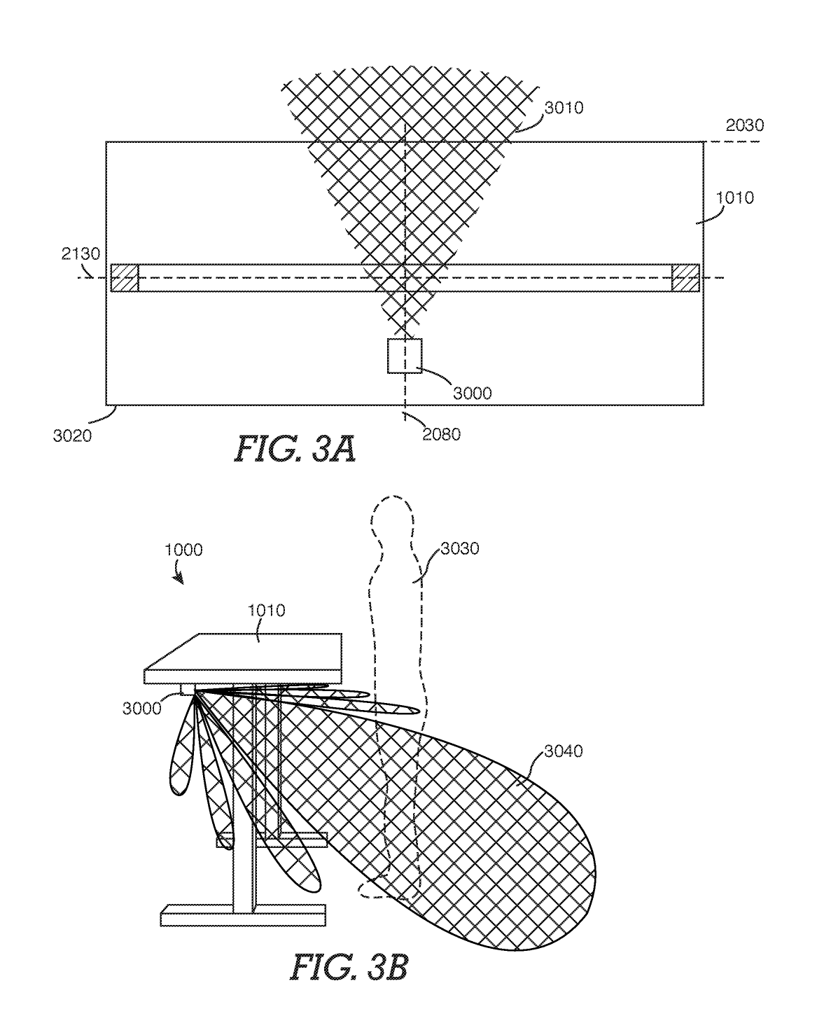

Certain embodiments of the present invention as shown in FIG. 3A comprise a radar transceiver 3000 that is mounted to the underside of a workstation work-surface 1010 and configured to transmit radio signals toward the leading longitudinal plane 2030 of the workstation 1000 or other identified region of user interaction with the workstation 1000. The field of detection 3010 of the radio signals transmitted toward the leading longitudinal plane 2030 of the workstation 1000 that are reflected back toward the radar transceiver 3000 provide data indicating if a user is present at the workstation and user proximity to the workstation 1000. A radar transceiver 3000 as used in such embodiments is typically mounted medial, coincident with the medial plane 2080 half the distance between the longitudinal midline 3010 and the trailing longitudinal edge 3020 of the workstation work-surface 1010.

Certain embodiments of the present invention comprise a workstation height sensor 2110 mounted to the underside of a workstation work-surface 1010 with a field of sensing 2120 directed downward toward the surface on which the workstation 1000 rests to determine the height of the workstation work-surface 1010. A workstation height sensor 2110 is typically mounted near the longitudinal midline 2130 of the workstation and proximate to a left distal edge 2140 or right distal edge 2150 of the workstation work-surface 1010. If desired, a redundant workstation height sensor 2160 may be used. A redundant workstation height sensor 2160 is typically located proximate to the opposite distal edge from the workstation height sensor 2110.

Certain embodiments of the present invention as shown in FIG. 3B comprise a radar transceiver 3000 to identify the presence of a user 3030 and the proximity of a user 3030 from a workstation 1000. In certain embodiments the radar transceiver unit is located centrally, proximate to the medial plane 2080 and mounted to the underside of the workstation work-surface 1010. The main lobe 3040 of the radar transceiver transmission is aimed toward an area where a user interacts with a virtual boundary. It will be appreciated to those skilled in the art that a main lobe 3040, as referenced with radar technology, surrounds the area of radar coverage with maximum power and field strength.

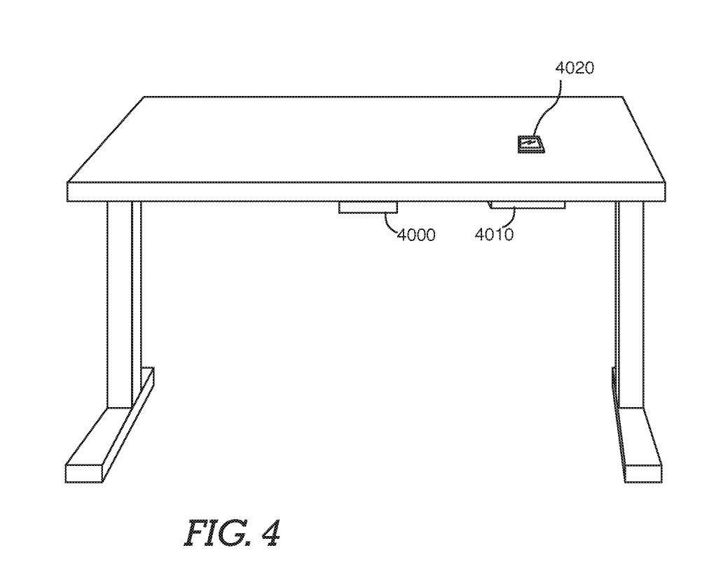

Referring to FIG. 4, certain embodiments of the present invention comprise a system having at least two sensors where a first sensor 4000 provides the ability for presence sensing, user orientation sensing, user proximity and workstation height sensing and a second sensor 4010 detects the presence of an electronic device 4020.

Certain embodiments utilize a thermal presence sensor 2060 affixed to the underside of a workstation work-surface 1010. The thermal presence 2060 sensor field of sensing 2070 is directed 25-45 degrees downward from the workstation work-surface 1010 and directed toward the intersection of the medial plane 2080 and the leading longitudinal plane 2030. The thermal presence sensor is typically mounted the underside of the workstation work-surface 1010 halfway between the medial plane 2080 and the distal left edge 2140 or the distal right edge 2150. Furthermore, the thermal sensor is typically mounted halfway between the longitudinal midline 2130 and the trailing longitudinal edge 3020 of the workstation work-surface 1010.

Certain embodiments of the invention comprise a computing device 1035, at least one sensor to provide feedback to the computing device 1035 surrounding user presence, user proximity, user orientation and workstation 1000 height. Such sensors may utilize technologies surrounding, but are not limited to the use of, one or more of the following: optical sensors, laser based optical sensors, infrared based optical sensors, acoustic sensors of the active and/or passive type, or radio based sensors including radar transceivers. Certain embodiments of the invention employ a plurality of sensors to provide feedback pertaining to user presence, orientation and workstation height to the computing device, while other embodiments utilize a singular sensor to provide feedback surrounding user presence, user orientation and workstation 1000 height to the computing device 1035.

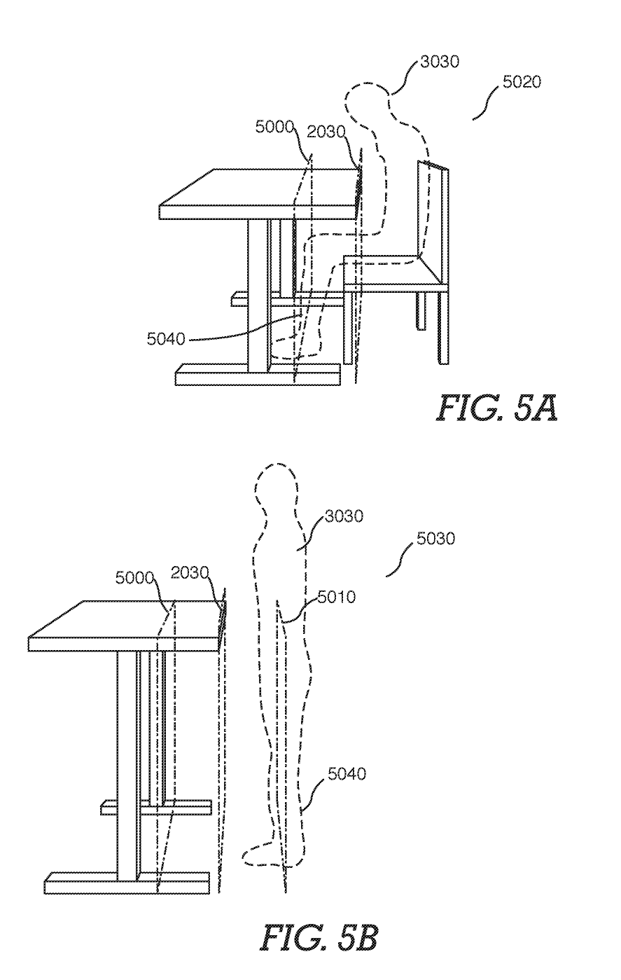

Certain embodiments of a system as shown in FIGS. 5A and 5B utilize at least one sensor to establish a virtual boundary. A virtual boundary may comprise the leading longitudinal plane 2030, a first offset plane 5000 or a second offset plane 5010 or three-dimensional boundaries established surrounding the relation of a user 3030 when using a workstation 1000. A virtual boundary in relation to physical detection systems defines a distance-based criteria for determining user 3030 presence at a workstation 1000. Furthermore, a first offset plane 5000 may further be used for determining user orientation to indicate a seated orientation 5020 or a second offset plane 5010 standing orientation 5030 of the user 3030 based on the distance of a user's legs 5040 in relation to a virtual boundary as shown by elements 5000 and 5010. It will be appreciated by those skilled in the art that a virtual boundary as used herein, surrounds the use of sensors to create an area, boundary or volume of sensor monitoring predetermined to be valuable in identifying and/or measuring changes in environment within the intended area of orientation sensor purview. A virtual boundary may be established by a sensor configuration to provide singular or multiple rays of sensing, a planar area under or around said workstation or a volume within working area of the workstation. Volumetric sensing strategies include but are not limited to the use of infrared illuminating lights with infrared optical sensing or radar technologies to provide a three-dimensional profile on, around or beneath a workstation. It will be appreciated that multiple virtual boundaries may be established within a system for a particular application. Virtual boundaries may be established for criteria surrounding user 3030 detection and user orientation including, but not limited to, maximum user distance from a workstation, minimum standing distance from a workstation, sensor location and seated leg extension.

In certain embodiments a radar transceiver 3000 is used as a user orientation sensor wherein the radar transceiver 3000 may detect the presence and proximity of a user 3030 in relation to the radar transceiver 3000. Given a predetermined distance of the radar transceiver 3000 to the leading longitudinal plane 2030 or virtual boundary, the system may determine if the legs of a user are closer to the sensor than the leading longitudinal plane, or closer than an established virtual boundary, inferring that a user may be in a seated orientation 5020. Conversely, if the radar transceiver 3000 detects a user's legs 5040 at a distance roughly equal to or greater than the distance of a leading longitudinal plane 2030, or established minimum standing distance virtual boundary, this implies the user may be in a standing configuration 5030.

In certain embodiments, a first sensor-suite 1020 is placed on the left or right side of the medial plane 2080 of the underside of a workstation work-surface 1010. The first sensor-suite 1020 further comprises a workstation height sensor 2160, user orientation sensor 2090, thermal presence sensor 2060, and a USB receptacle 1040. A first sensor-suite 1020 further comprises a computing device 1035, and data or information is transferred between a separate embodiment of a first sensor-suite 1020 installed on a different workstation 1000 within a network through wireless means, such as for example Wi-Fi, Bluetooth®, NFC, or wired communication protocols.

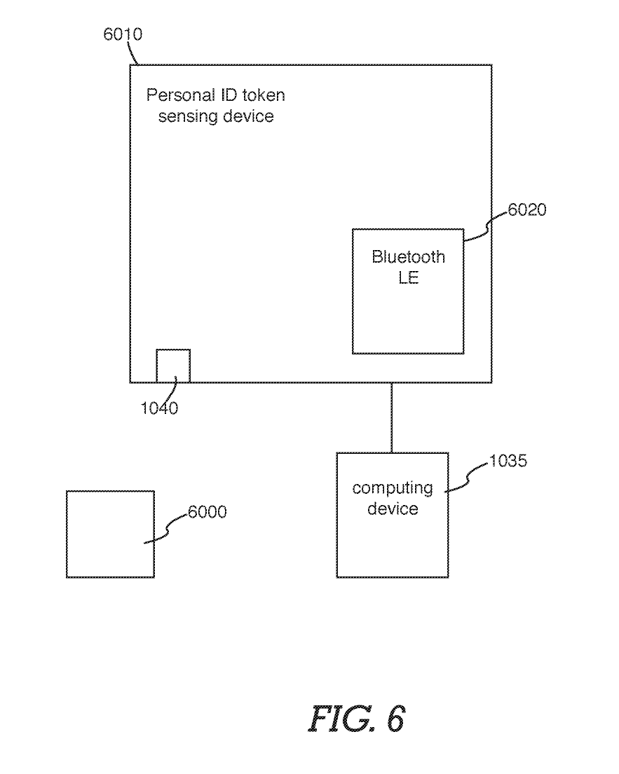

Certain embodiments of the present invention as shown in FIG. 6, use identity detection through the proximity of a personal identification token 6000. As shown an wireless personal identification token 6000 can be carried or worn by the user, placed on the workstation work-surface 1010 for wireless detection, or plugged into a USB receptacle 1040 in the case of a USB type personal identification token 6000. A personal identification token 6000 may comprise, but is not limited to an RFID identifying device, an NFC identifying device, USB based device or a wireless transmitting device enabled with a wireless communicating protocol such as, but not limited to Wi-Fi, Zigbee®, Bluetooth®, low energy Bluetooth® (Bluetooth® LE) and/or Bluetooth® 4.0. A personal identification token 6000 may comprise an object with preprogrammed identifying information in electronic or digital form, such as the user's name, height, age, sex and workstation use activity data. While a personal identification token remains engaged wirelessly or inserted in a receptacle, the system is provided with identification regarding a user detected as present at a workstation. Alternative embodiments of a personal identification token 6000 may comprise, but are not limited to, a Bluetooth® enabled phone, smart watches, wearable fitness bands, USB tokens or other computing device 14.

It will be appreciated by one skilled in the art that identifying information may comprise user identifying information such as said user's name or other personal information or a unique number, character string or a combination thereof, assigned to a user and cross-referenced with a separate database to increase user anonymity and/or user privacy and security.

In certain embodiments of the invention as shown in FIG. 6, a system employs the use of a plurality of personal identification token 6000 sensing for positive user identification. A personal identification token sensing element 6010 comprises a USB receptacle 1040 and Bluetooth® LE communication module 6020. Positive user identification occurs when a USB type personal identification token 6000 is inserted in the intended USB receptacle 1040 or a Bluetooth® type personal identification token 6000 is wirelessly recognized. The personal identification token sensor element 6010 is typically mounted to the underside of the workstation work-surface 1010 provides positive recognition of a personal identification token 6000 which is then communicated with the computing device 1035.

In certain embodiments of the invention, one personal identification token 6000 may be paired with the system at a time. In the event of multiple personal identification tokens of similar type, such as multiple detectable wireless personal identification tokens 6000 or multiple detectable USB dongle based personal identification tokens 6000, the initially paired personal identification token 6000 will remain paired with the system and a subsequently detectable personal identification token 6000 is ignored.

In the event of multiple personal identification tokens 6000 of differing types, a hierarchy of types of personal identification tokens 6000 may be preprogrammed. In certain embodiments, a personal identification token 6000 in the form of a USB type personal identification token 6000 may supersede a wireless based personal identification token 6000 such as those utilizing Bluetooth®, RFID or near-field communication technology. For example, if a wireless based personal identification token 6000 is paired with the system and a user 3030 inserts a USB type personal identification token 6000 into a USB receptacle 1040, the USB based personal identification token 6000 supersedes the wireless based personal identification token 6000. It will be appreciated that the hierarchy of personal identification token 6000 types may be modified by a user 3030 or administrator of the system to any desired order.

In certain embodiments, for the detection of a Bluetooth® LE, the personal identification token 6000 initiates a pairing sequence within the system wherein the Bluetooth® LE personal identification token 6000 must be detectable within the range of the system for a predetermined period of time prior to pairing. Furthermore, when a Bluetooth® LE personal identification token 6000 is paired with the system, a second Bluetooth® LE personal identification token 6000 may not pair with the system.

In certain embodiments, when a user 3030 is the sole user of a given workstation, the user 3030 may be set as a default user. In such embodiments, the sensed physical presence of a user 3030 is registered with the identity of the default user without he requirement of a personal identification token 6000.

In certain embodiments, a system comprises a personal identification token 6000, the detection of a personal identification token 6000 provides the system with personal information, preferential standing orientation or sitting orientation use and preferred workstation heights for standing and sitting use of a dynamic standing workstation. The personal information includes user height, gender, age, name and any other predetermined personal information as identified by a user, employer or third-party. In such embodiments, the system may adjust the height of the dynamic standing workstation according to the recorded preferred workstation heights. The system may adjust workstation height according to a user's recorded preference upon command from the user 3030, in compliance with predetermined time periods of allowable seated or required standing use dictated by the user's employer or other interested party such as a insurance provider.

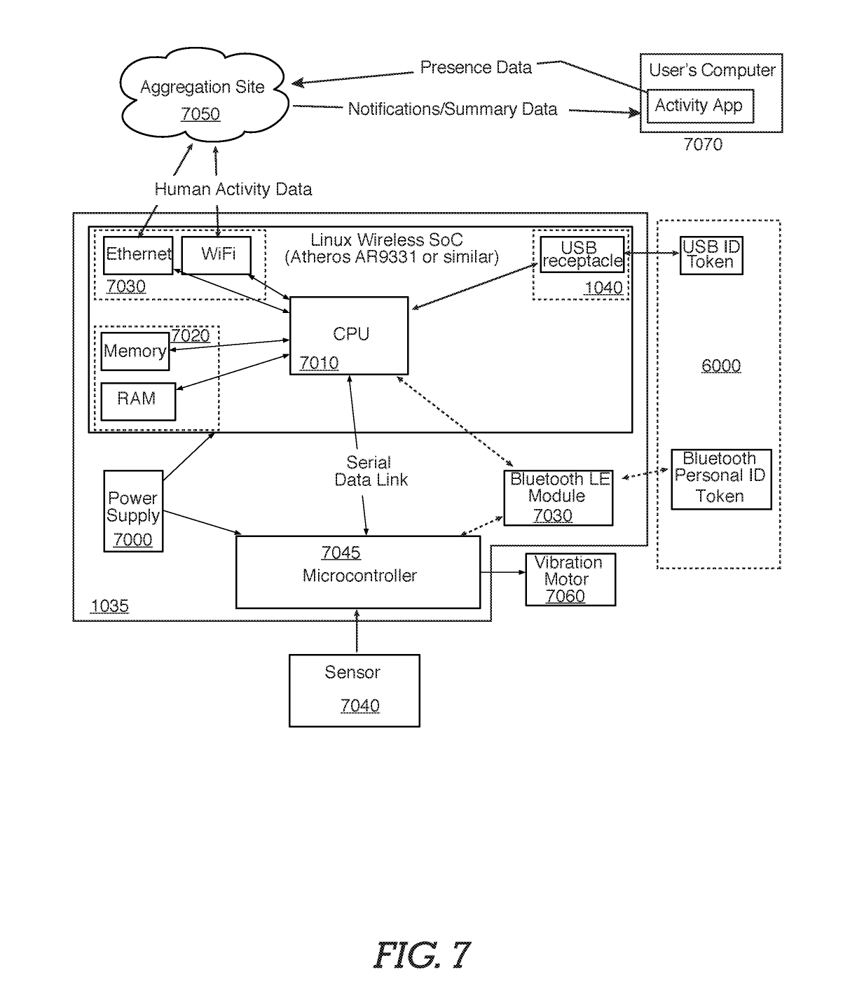

It will be appreciated that a computing device 1035, as shown in FIG. 7, comprises a power supply 7000, central processing unit 7010, memory 7020, data transfer modules 7030 and a USB receptacle 1040. It will be further appreciated said computing device 1035 receives sensor data 7040 through a microcontroller and the sensor data 7040 is input, analyzed based on preprogrammed analysis processes, stored and transmitted to associated systems and software such as a cloud platform or web based aggregation site 7050.

In certain embodiments of the invention, the computing device is connected to the user's computer 7070 with software surrounding the tracking of use of the workstation. In such embodiments, the computing device 1035 connects to associated sensors through the use of standard communication protocols of the wired or wireless type known to those skilled in the art.

In certain embodiments of the present invention, at least one sensor is mounted on the bottom surface of the workstation work-surface 1010. The sensor may work in a capacity as a workstation height sensor 2110, user orientation sensor 2090, a presence sensor 2010 or a combination thereof. A workstation height sensor 2110 provides sensing generally toward the supporting surface on which the workstation rests, such as a floor 19, as illustrated in FIG. 3B to provide the system the distance from the workstation height sensor 2110 to the surface on which the workstation 1000 rests. Given a workstation work-surface 1010 thickness indicating offset distance between workstation work-surface 1010 and workstation height sensor 2110 mounting surface, this information provides the system with information regarding the distance of the workstation work-surface 1010 from the surface on which the workstation 1000 rests. Furthermore, a user orientation sensor 2090 typically provides sensing downward and inward toward the medial plane 2080 of the workstation.

In certain embodiments of a system attached to a workstation 1000, an orientation sensor 2090 intended to detect user 3030 presence, specifically their legs 5040, beneath a workstation 1000 is mounted offset from the medial plane 2080 to the underside of a workstation work-surface 1010. The orientation sensor 2090 is directed downward and either parallel to or directed toward the leading longitudinal plane 2030. The angle of orientation is between 25 and 45 degrees downward, and more preferably 25-35 degrees downward from the workstation work-surface 1010 and up to 10-degrees toward the leading longitudinal plane 2030. In certain embodiments the detection of an object by an orientation sensor 2090 within a predetermined threshold distance is recognized as a user 3030 in a seated configuration 5020.

In certain embodiments, an orientation sensor 2090 is mounted to the underside of a workstation work-surface 1010, offset from the medial plane 2080 and typically in the front half of the workstation 1000. The sensing direction of the orientation sensor 2090 is parallel to the leading longitudinal plane 2030 or angled toward the leading longitudinal plane 2030 by up to 10-degrees. The orientation sensor 209 is directed 25-35 degrees downward away from the workstation work-surface 1010. The orientation sensor 2090 on either sides of the medial plane 2080, typically equidistant from the medial plane 2080 and the left distal edge 2140 or the right distal edge 2150. A thermal presence sensor 2060 is mounted to the underside of the workstation work-surface 1010 offset from the medial plane 2080, typically on the back half of the workstation work-surface 1010 offset from the medial plane 2080 and typically equidistant from the medial plane 2080 and the left distal end 2140 or the right distal edge 2150. It may be preferred to mount the thermal presence sensor 2060 on the opposite side of the medial plane 2080 from the orientation sensor 2090. The thermal presence sensor 2060 is angled toward the intersection of the leading longitudinal plane 2030 and the medial plane 2080 and directed 25-45 degrees downward from the workstation work-surface 1010.

In certain embodiments, after detecting the presence of a user 3030 the system detects the orientation of the user 3030 indicating a seated position 5020, as shown in FIG. 5A, or a standing position 5030, as shown in FIG. 5B. The system then may provide this information to the computing device 1035 for communication with a cloud based or web based aggregation site 7050.

In certain embodiments, a system comprising a first sensor-suite 1020 is affixed to a workstation 1000. In such embodiments, a presence sensor 2010 checks for the presence of a user 3030, a user orientation sensor 2090 determines user orientation and a workstation height sensor 2110 determines the height of the workstation 1000 on pre-programmed intervals. If the system detects a personal identification token 6000, the system associates the information collected from the presence sensor 2010, the user orientation sensor 2090, and the workstation height sensor 2110 with the identity of the user 3030. If the system detects the presence of the user 3030, detects the orientation of the system to be consistent with a sitting orientation 5020 and identifies the user 3030, the system merges the information and communicates it with the aggregation site 7050 recording a seated orientation 5020. If the system detects the presence of the user 3030, detects the orientation of the system to be consistent with a standing orientation 5030 and identifies the user 3030, the system merges the information and communicates it with the aggregation site 7050 recording a seated orientation 5030.

In certain embodiments, a radar transceiver 3000 provides the functionality of a user presence sensor 2010, a user orientation sensor 2090 and a workstation height sensor 2110. In such embodiments, a radar transceiver 3000 is typically mounted medially to the underside of the workstation work-surface 1010 with the main lobe 3040 of the radar transmission of the radar transceiver 3000 oriented to provide detection of a user 3030 presence, user 3030 orientation and workstation 1000 height. It will be appreciated that a plurality of radar transceivers 3000 may be used if desired.

In certain embodiments of the invention, a system provides notification to a user with suggestions to change orientation based on a predetermined amounts of time associated with a seated orientation 5020 or a standing orientation 5030. Such notifications may be provided through auditory, haptic or visual notifications. Such notifications may be provided through, but are not limited to, audible sounds, vibration, alerts through wirelessly connected devices such as smartphones, wearable technology, computers and other devices appreciated by one skilled in the art. It will be appreciated that the initiation of a notification may be indicated by a web based or cloud based application, predetermined intervals or by an interested third-party.

In certain embodiments, the user is provided with notifications suggesting a seated orientation 5020 or a standing orientation 5030, for healthy workstation use. Healthy workstation is determined by the user, an employer or health insurance provider or other interested party and can be programmed into the system. Notifications are provided to the users through haptic notifications through the use of vibration motor 7060 as shown in FIG. 7 and through communication modules 7030 such as Bluetooth® LE connection to a user's smartphone or other wirelessly connected device.

In certain embodiments, a sensor-suite comprising three sensors, including a workstation height sensor 2110 and a user orientation sensor 2090 and a user presence sensor 2010. The first sensor-suite 1020 is typically mounted to the front right or front left quadrant of the underside of the workstation work-surface 1010. The workstation height sensor 2110 is directed vertically downward, the presence sensor 2010 toward the intersection of the medial plane 2080 and the leading longitudinal plane 2030 and 25-45 degrees downward, and the user orientation sensor 2090 is directed downward at an angle of 25-35 degrees and between 0 and 10-degrees toward the leading longitudinal plane 2030. Alternate embodiments comprise a second sensor-suite 1030 mounted in the opposite front-quadrant of the first sensor-suite 1020, mirroring the first sensor-suite 1020. A plurality of user orientation sensors 2090 may be used to provide redundancy in detection of workstation 1000 height but more specifically redundancy in detection of a user's legs 5040 beneath the workstation 1000 thereby indicating seated orientation 5020 in use of the workstation.

Certain embodiments of the present invention comprise a workstation height sensor 2110 to determine the height of the workstation 1000. Alternative embodiments comprise a plurality of workstation height sensors 2110 to provide feedback redundancy to differentiate between workstation height variation and objects placed under a workstation such as a trashcan or boxes.

In certain embodiments of the present invention, a threshold distance can be set characterizing a maximum seated height. When a workstation height sensor 2110 indicates the workstation work-surface 1010 is equal to or less than the maximum seated height, it is assumed that in the presence of a user 3030, that user 3030 is using the workstation 1000 in a seated orientation 5020. In certain embodiments of the invention, the maximum seated height is 93.98 cm (37 inches). Thus, when the workstation 1000 is measured at a work-surface 1010 height of 93.98 cm (37 inches) or lower, it is inferred that a present user 3030 of that workstation 1000 is in a seated orientation 5020.

In certain embodiments of the invention, a system enables the sensing and recognition of dynamic vertical distance from the floor 1050, as shown in FIG. 1, associated with worksurface 1010 motion associated with the change in workstation work-surface 1010 height and the active placement of foreign objects such as trashcans and boxes beneath the workstation. This is accomplished with the use of continuous or semi-continuous height monitoring to detect continuous and consistent vertical motion. A workstation height sensor 2110 provides input to the system to differentiate between dynamic motion associated with vertical height change of the workstation 1000 and placement of foreign objects beneath the workstation 1000. It will be appreciated to those skilled in the art that height change, or the distance between the workstation work-surface 1010 and the floor 1050 is typically characterized as a gradual and/or consistent rate of change not exceeding a certain identified rate of change. It will be further appreciated that a workstation height sensor 2110 may not be able to differentiate between an object placed beneath a workstation 1000 and the floor 1050, however it will be appreciated that the system, may identify the placement of an object beneath a workstation through sensing a sudden and near instantaneous height change. Further, the system may identify the placement of an object beneath a workstation 1000 through inconsistencies of measurement by a workstation height sensor 2110 in different areas below a workstation 1000 or by additional workstation height sensors 2110 when a plurality of workstation height sensors 2110 are employed. Such differentiation can be identified using preset or user programmed profiles and/or profiles associated with general workstation 1000 actuation characteristics as well as specific workstation types such as manual, electrically driven and pneumatic or specific to a particular workstation.

Certain embodiments of the system identify continuous and consistent rates of motion with the raising and lowering of a workstation 1000 height through the use of workstation height sensors 2110. Such movement associated with the height adjustment of a dynamic height workstation 1000 is typically identified with an initial and terminal ramp-up or ramp-down rate periods with an intermediate rate. Furthermore, such motion is substantially gradual versus the placement of an object beneath the workstation that occurs within a brief period of time, typically in less than 0.5 seconds.

In certain embodiments, the system may recognize height adjustment rate ranges associated with different style dynamic height workstations 1000. In such embodiments, the system recognizes linear motion through the continuous monitoring of workstation 1000 height with a workstation height sensor 2110. Typically, a rate of motion of 2.79-4.32 cm (1.1-1.7 in) per second is associated with motion indicative of height adjustment of an electrically driven dynamic height workstation 1000, while a rate of motion of 1.27-1.91 cm (0.5 in-0.75 in) per second is associated with motion indicative of height adjustment of a manually driven dynamic height workstation 1000.

In certain embodiments, a system is attached to an adjustable height workstation 1000, with electronic controls. The electronic controller of the workstation 1000 may provide direct feedback to the system surrounding the height set point of the workstation.

In certain embodiments of the present invention, an orientation sensor 2090 detects user 3030 presence by sensing the presence of a user's legs 5040 and how far they extend beneath a workstation 1000, or beyond an established virtual boundary, and measuring the distance between identified objects and an orientation sensor 2090. The distance of a user's legs are identified as objects ranging from 0-76.2 cm (0-30 in) from an orientation sensor 2090. This solves the problem of false-positive detection in which a system believes a user 3030 to be in a standing 5030 orientation when they in fact are in an elevated seated orientation 5020 in use of a standing height workstation 1000. In certain embodiments, the system comprises a computing device 1035, a thermal presence sensor 2060, a user orientation sensor 2090 a workstation height sensor 2110 and a personal identification token 3000. Such embodiments of this system may be mounted to any workstation 1000 and is not platform specific. That is, the invention can be used with any workstation 1000, particularly those allowing a standing orientation 5030 use. Associated hardware in the form of the computing device 1035 and sensors 2060, 2090, 2110 are affixed to the workstation 1000 with common methods appreciated by one skilled in the art such as, but not limited to, adhesive, hook-and-loop, mechanical hardware and/or magnets. In such embodiments the computing device 1035 provides identification recognition and communicates information to associated systems, which interface directly or indirectly with healthcare and/or health insurance providers.

In certain embodiments, as seen in FIG. 7, the present invention comprises a computing device 1035, a personal identification token sensor unit 6010, a thermal presence sensor 2060, a workstation height sensor 2110 and a user orientation sensor 2090 allowing the use with any fixed-height or adjustable-height workstation 1000, but is intended for use with those that allow standing orientation 5030 use. In such embodiments, the ability to function with any fixed height or adjustable workstation 1000 solves the problem surrounding cost commonly associated with purchase of new infrastructure to enable active tracking and processing of user data in reference with the use of a workstation 1000 in a standing configuration 5030.

In certain embodiments, the system comprises a first sensor-suite 1020 offset from the medial plane 2080 and offset from the leading longitudinal plane 2030. The first sensor-suite 1020 further comprises a computing device 1035, more specifically a Linux Wireless SoC with USB receptacle 1040, Bluetooth® LE module 6020, microcontroller 7045, thermal presence sensor 2060, presence sensor 2010, workstation height sensor 2110, user orientation sensor 2090 and vibration motor 7060. If so desired, a second sensor-suite 1030 may be used. In such cases the second sensor-suite 1030 is mounted offset the medial plane 2080 on the opposite side from the first sensor-suite 1020 and offset from the leading longitudinal plane. Such a second sensor-suite 1030, comprises a user orientation sensor 2090, a workstation height sensor 2110 and a user presence sensor 2010. The second sensor-suite 1030 communicates with the first sensor-suite 1020, more specifically the microcontroller 7045, through the use of multi-conductor wired communication protocols. The multi-conductor wires used in such communication also provide power to the user orientation sensor 2090, workstation height sensor 2110 and presence sensor 2010 of the second sensor-suite 1030. In alternate embodiments, the second sensor-suite 1030 communicates with the first sensor-suite 1020 through wireless communication protocols.

In certain embodiments, the present invention comprises a computing device 1035, a personal identification token sensor unit 6010, and a radar transceiver 3000. In such embodiments the radar transceiver 3000 provides sensing functionality as a presence sensor 2010, workstation height sensor 2110, and user orientation sensor 2090. Such embodiments may be used with a fixed-height or adjustable-height workstation 1000, but is intended for use with a workstation 1000 allowing standing user orientation 5030. This allows the use of the system with any fixed height or adjustable workstation 1000 to actively track and process user data in reference to the workstation. In certain embodiments, the present invention comprises a first sensor-suite 1020 comprising a Linux Wireless system on chip with USB receptacle 1040, Bluetooth® LE module 6020, microcontroller 7045, radar transceiver 3000 comprising the sensor 7040 and vibration motor 7060 wherein the vibration motor 7060 is capable of providing haptic notifications or feedback surrounding user 3030 use habits with the workstation 1000.

In use, as demonstrated in FIG. 7, certain embodiments of the invention are affixed to a given workstation 1000 and provided a power source 7000, typically 5 Volt DC power. A workstation 1000 with an embodiment of the system, the system performs a series of three decision processes in coordination with the sensor-suites 1 to determine the workstation height, user presence, user identity, and user orientation to merge this data into a message and communicate with cloud-based platform and/or web application. From the cloud-based platform and web application, this information can be further provided to users through the user of a web-based dashboard, smartphone application or the like. Furthermore, the cloud-based platform or web based application can provide feedback through the embedded computer to provide notification to the user via vibration motor or Bluetooth® LE to modify their orientation in use of the workstation.

In certain embodiments, the present invention comprises a method for determining the use of the workstation 1000 by a user 3030. If the presence of a user 3030 is detected by a presence sensor 2090 and a workstation height sensor 2110 indicates that the workstation 1000 height is consistent with a seated configuration 5020, or if the user orientation sensor 2090 detects the presence of the user's legs 5040 as crossing a predefined virtual boundary such as a first offset plane 5000 characterizing seated use; the system registers the user orientation as a seated orientation 5020. If the presence of a user 3030 is detected by a presence sensor 2010 and a workstation height sensor 2110 indicates the workstation is at a height predefined as a potential standing use configuration 5030 and a user orientation sensor 2090 detects the presence of the user's legs 5040 as not crossing a predetermined virtual boundary such as a second offset plane 5010, the system registers the user orientation as standing a standing orientation 5030.

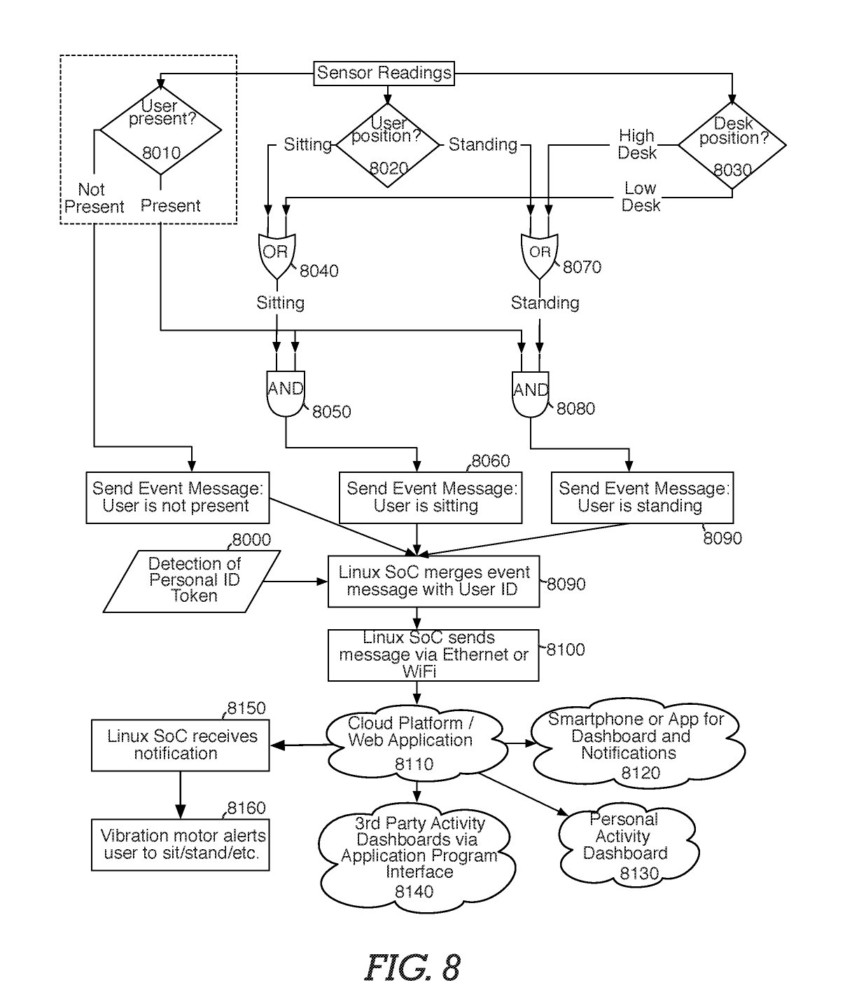

Certain embodiments of the present invention, as shown in FIG. 8, comprise a system integrated with a workstation 1000, further comprising a computing device 1035, a personal identification token sensor unit 6010, a thermal presence sensor 2060, a workstation height sensor 2110 and a user orientation sensor 2090. When personal identification token detection occurs 8000 by the personal identification token sensor unit 6010 communicates the information from the personal identification token 6000 to the computing device 1035. The assessments of user presence 8010, the assessment of user orientation 8020 and the assessment of workstation height 8030 are performed on predetermined intervals. The assessment of user presence 8010 can return a result indicating “present” or “not present.” The assessment of user position 8020 can return a result indicating a seated orientation 5020 or a standing orientation 5030. The assessment of workstation position can return a “low” result indicating seated orientation 5020 or a “high” potential standing orientation 5030. If the result of the assessment of user presence 8010 is “not present”, an event message of “not present” is communicated 8020 with the computing device 1035. If the assessment of user presence 8010 returns a result of “present” and the assessment of user position returns an indication of seated orientation 5020 or the assessment of workstation position returns a result of “low workstation,” the results are combined as shown in elements 8040 and 8050 to send event message “user is sitting” 8060. If the assessment of user presence 8010 returns a result of “present” and the assessment of user position returns an indication of standing orientation 5030 or the assessment of workstation position returns a result of “high workstation,” the results are combined as shown in elements 8070 and 8080 to send event message “user is sitting” 8060. When an event message is sent as in elements 8060 or 8080, it is sent to the computing device 1035 and the personal identification token detection 8000 and the event message 8060 or 8080 are merged 8090. The merged message is sent 8100 by the computing device 1035 via wired or wireless communication protocol to an aggregation site 7050 in the form of a cloud platform or web application 8110. The messages received by the aggregation site can then be accessed through mobile applications, computer based dashboards, web-based interfaces, personal activity dashboards as shown in elements 8120 and 8130. The aggregated messages can also be accessed by approved third parties 8140 such as employers or insurance providers. The aggregation site can send messages 8150 to the computing device 1035 based on predetermined analysis processes, predetermined intervals or third party initiated alerts to provide notification to the user to transition to a sitting or standing orientation 8160. These alerts can be delivered to the user through haptic feedback such as through a vibration motor 7060, through a smartphone connected wirelessly to the system or other methods as appreciated to those skilled in the art.

In certain embodiments, a system further comprises a software-based application installed on a computer or laptop, which is in communication with the computing device 1035. Such an application can relay messages to the user through the use of on-screen notifications such as notifications indicating that the user should change their orientation in use of the workstation. It may be desired for such an application to deliver alerts only when there is a lack detected user activity with the computer or computer input devices so as to prevent interrupting user workflow and productivity.

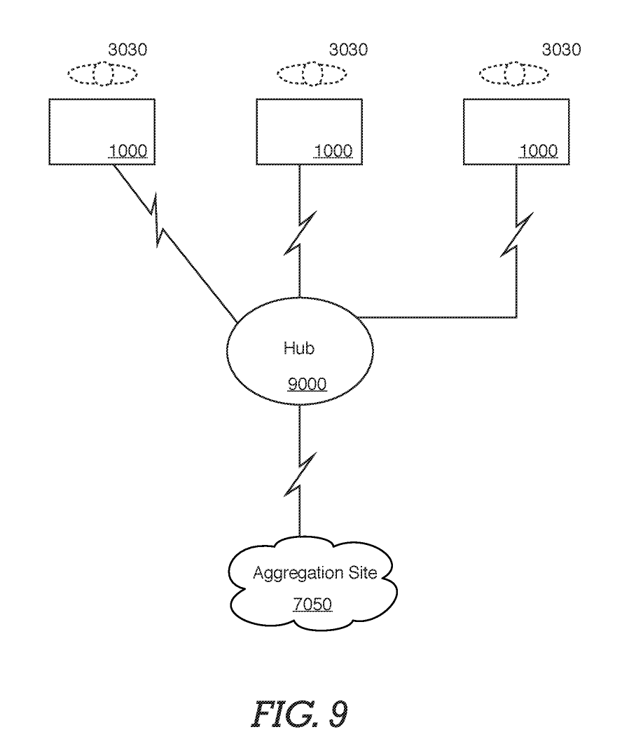

Certain embodiments of a system as disclosed herein further at least one, and more typically a plurality of systems, each integrated with a workstation 1000 for the tracking of user 3030 interaction with each workstation 1000 and communication of resultant collected data to an aggregation site 7050. Referring to FIG. 9, a system in such an embodiment may comprise wireless communication protocols such as Bluetooth® or radio frequency communication to deliver system messages to a intermediate hub 9000 or gateway which then relays such messages to the aggregation site through wireless communication protocols such as Wi-Fi or Ethernet communication. It will be appreciated by those skilled in the art that communication protocols such as Wi-Fi or Ethernet are communication protocols supported by the IEEE 802 family of standards. For example, Wi-Fi is supported by the IEEE 802.11 standard, Ethernet is supported by the IEEE 802.3 standard and Bluetooth® is supported by the IEEE 802.15.1 standard.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “proximal,” “distal,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. The benefits, advantages, solutions to problems, and any element(s) that may cause any benefit, advantage, or solution to occur or become more pronounced are not to be construed as a critical, required, or essential features or elements of any or all the claims.

What is claimed:

1. A system for the monitoring interactions of a user with a workstation comprising:
a computing device, said computing device comprising a central processing unit (CPU),
a power source connected to said computing device;
a first wireless communication component;
a first wired communication component;
a first sensor mounted to the underside of a work-surface of said workstation; said first sensor providing at least one sensing function selected from the group consisting of: user presence sensing, user orientation sensing and workstation height sensing;
a personal identification token, said personal identification token comprising identifying information and;
an aggregation site;
wherein the integration of said system with a workstation senses, records and communicates said interactions surrounding said workstation.

2. The system of claim 1, further comprising a microcontroller wherein said first sensor communicates with said computing device through said microcontroller.

3. The system of claim 1, wherein said first wireless communication component comprises Bluetooth® LE communication protocol capability and said personal identification token comprises Bluetooth® LE communication protocol capability.

4. The system of claim 1, wherein said first wired communication component comprises a USB receptacle and said personal identification token comprises a USB dongle.

5. The system of claim 1, further comprising a second sensor and a third sensor wherein said first sensor comprises infrared sensing directed to user presence sensing, said second sensor comprises infrared sensing directed to user orientation sensing, said third sensor comprises infrared sensing directed to workstation height sensing; and said first sensor, said second sensor, and said third sensor communicate with said computing device.

6. The system of claim 5, wherein said first sensor is mounted to the underside of the workstation work-surface equidistant from a medial plane a left distal end or a right distal end, said first sensor further being mounted between a longitudinal midline and a trailing longitudinal edge of the workstation work-surface, and said first sensor having a field of sensing directed 25-45 degrees downward from the workstation work-surface and directed toward the intersection of said medial plane and a leading longitudinal edge of the workstation work-surface.

7. The system of claim 5, wherein said second sensor is mounted to the underside of the workstation work-surface laterally offset from a medial plane and equidistantly from a leading longitudinal edge and a longitudinal midline, said second sensor having a field of sensing directed downward from the workstation work-surface and between 0-10 degrees toward the leading longitudinal edge.

8. The system of claim 5, wherein said third sensor is mounted to the underside of the workstation work-surface offset from a medial plane and between a longitudinal midline and a leading longitudinal edge, said third sensor having a field of sensing directed vertically downward.

9. The system of claim 1, further comprising a microcontroller connected to said power supply, wherein said first sensor communicates with said microcontroller, wherein data from said first sensor is sent from said microcontroller to said computing device.

10. The system of claim 1, further comprising a vibration motor, wherein a notification sent by said computing device delivers haptic feedback generated by said vibration motor.

11. The first wired communication component of claim 1, further comprising Ethernet communication protocol hardware; wherein said data from said first sensor is communicated by said computing device through said first wired communication to said aggregation site and communications from said aggregation site are received by said computing device through said first wired communication component.

12. The first wireless communication component of claim 1, further comprising Wi-Fi communication protocol hardware, wherein said data from said first sensor is communicated by said computing device through said first wireless communication to said aggregation site and communications from said aggregation site are received by said computing device through said first wireless communication component.

13. The system of claim 1, wherein said first sensor comprises a radar transceiver unit mounted to the underside of a workstation work-surface, said radar transceiver unit having a field of sensing directed toward a leading longitudinal edge of a workstation work-surface.

14. The system of claim 13, wherein said field of sensing is directed such that a main lobe is directed toward the intersection of a medial plane and said leading longitudinal edge.

15. The system of claim 13, wherein said radar transceiver is mounted coincident with said medial plane and between a longitudinal midline and a trailing longitudinal edge of said workstation work-surface.

16. The system of claim 1, further comprising a second system and an intermediate hub wherein; said system and said second system communicate with said aggregation site through said intermediate hub through a wireless communication protocol.

17. A method of monitoring user interaction with a workstation comprising:
(a) identifying a personal identification token configured to store workstation usage;
collecting information from said personal identification token;
(b) communicating said information from said personal identification token to a computing device;
(c) determining the presence of a user at the workstation;
(d) assessing user orientation to determine whether a user is seated or standing; and
(e) determining workstation height.

18. The method of claim 17, further comprising:
(f) generating an event message that a user is standing or a user is sitting;
(g) merging said event message with said step of collecting information to create a merged message;
(h) sending said merged message to an aggregation site;
(i) confirming the receipt of said merged message by said aggregation site;
(j) storing, analyzing and recording in a database of said merged message for access through a smartphone app, web portal, activity dashboard or by a third-party;
(k) delivering a notification based on said analyzing step to said computing device to notify said user to modify user orientation.
